(19) United States
(12) Patent Application Publication
(10) Pub. No.: US 2019/0378155 A1
(43) Pub. Date: Dec. 12, 2019

(54) TIME CRITICAL INVENTORY CONTROL SYSTEMS AND METHODS

(71) Applicant: Live Inc., Scottsdale, AZ (US)

(72) Inventor: Keith Wong, Scottsdale, AZ (US)

(21) Appl. No.: 16/190,484

(22) Filed: Nov. 14, 2018

Related U.S. Application Data
(60) Provisional application No. 62/683,811, filed on Jun. 12, 2018.

(51) Int. Cl. G06Q 30/02; H04W 4/23; G06Q 20/38

(52) U.S. Cl. CPC G06Q 30/0223; H04W 4/23; G06Q 2220/00; G06Q 20/387; G06Q 30/0284

(57) ABSTRACT

Apparatus and associated methods relate to a perishable product inventory control system configured to predict a perishable product surplus quantity at a location and time determined as a function of product expiration time, associate the predicted product surplus to a shopper seeking the product at the predicted location and time, and, automatically offer the shopper a portion of the product surplus discounted as a function of the perishable product surplus expiration time. In an illustrative example, the product surplus quantity, location, and time may be calculated based on inventory level and consumption rate. The product surplus location and time may be, for example, a restaurant's closing time, permitting the shopper to receive an offer to purchase a meal discounted as a function of time remaining until closing. Various examples may advantageously reduce cost and waste, based on matching shoppers with perishable products discounted as a function of product expiration time.

### CROSS-REFERENCE TO RELATED APPLICATIONS

This application claims the benefit of U.S. Provisional Application No. 62/683,811, titled “A business model that brings together four interested parties to a commercial transaction in such a manner that each contributes tangible and intangible assets that in aggregate they make themselves more confident and willing to consummate the transaction,” first named inventor Keith Wong, filed by Keith Wong on 12 Jun. 2018.

This application incorporates the entire contents of the foregoing application herein by reference.

### TECHNICAL FIELD

Various embodiments relate generally to inventory control, and more specifically, to time critical perishable inventory control.

### BACKGROUND

Business transactions are transactions that exchange assets having value. Some business transactions include a buyer and a seller. In some examples, a buyer may pay a price determined by a seller to purchase a good or service offered for sale by the seller. In an illustrative example, some business transactions may involve assets with value that may change with time.

Some business transaction assets may have greater value as time advances. For example, in various examples, real estate may increase in value over time. Various assets may have value that decreases with time. In an illustrative example, a hotel room's value may decline significantly if the room is not rented early in the evening. Some assets may become a total loss to a business if not exchanged for another valuable asset in a business transaction before a certain time. For example, a sandwich for sale in a delicatessen may need to be discarded if the sandwich is not sold before the delicatessen closes.

Various assets having time-dependent value may be produced in quantity and offered in advance at a discount to shoppers. Some products or services to be offered at a discount may be overproduced, leading to a monetary loss for the business. A business offering products or services with time-critical value may waste or dispose of valuable inventory or resources as the expiration time of the product, service, or resource passes.

### SUMMARY

Apparatus and associated methods relate to a perishable product inventory control system configured to predict a perishable product surplus quantity at a location and time determined as a function of product expiration time, associate the predicted product surplus to a shopper seeking the product at the predicted location and time, and, automatically offer the shopper a portion of the product surplus discounted as a function of the perishable product surplus expiration time. In an illustrative example, the product surplus quantity, location, and time may be calculated based on inventory level and consumption rate. The product surplus location and time may be, for example, a restaurant's closing time, permitting the shopper to receive an offer to purchase a meal discounted as a function of time remaining until closing. Various examples may advantageously reduce cost and waste, based on matching shoppers with perishable products discounted as a function of product expiration time.

Various embodiments may achieve one or more advantages. For example, some embodiments may improve a shopper's ease of access to products or services. This facilitation may be a result of reducing the shopper's effort locating products or services preferred by the shopper. In some embodiments, discounted products or service may be automatically offered to a shopper interested in the product or service. Such automatic product or service discounts may reduce a shopper's cost obtaining the shopper's preferred products or services. Some embodiments may make premium products or services more affordable to a shopper. Such increased affordability may be a result of offering the shopper discounted premium products or services. In some examples, a shopper's trust in new products or services may be expanded. This facilitation may be a result of providing a trusted service offering the shopper discounted products and services.

In some embodiments, the effort required by a seller to reach new customers may be reduced. This facilitation may be a result of associating a product surplus predicted at a particular location and time with a potential customer seeking the product at the predicted location and time. For example, a shopper who registers interest in a delicatessen sandwich at closing time may receive a discounted offer to purchase a sandwich not previously affordable to the shopper. In some embodiments, a seller's product waste may be reduced. Such reduced waste may be a result of turning a total loss when a product perishes to a partial gain in revenue after discounting. In various examples, a seller's brand building effectiveness may be improved. Such brand building effectiveness may be a result of providing a trusted platform service marketing perishable products and services. In an illustrative example, a seller's ability to maintain a regular price structure while offering deep discounts may be enhanced. This facilitation may be a result of discreetly offering deep time-dependent discounts on perishable goods to individual customers while maintaining a regular pricing structure facing the public.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary operational scenario illustrative of an embodiment collaboration network configured with a perishable product inventory control system adapted to predict a perishable product surplus quantity at a location and time determined as a function of product expiration time, associate the predicted product surplus to a shopper seeking the product at the predicted location and time, and, automatically offer the shopper a portion of the product surplus discounted as a function of the perishable product surplus expiration time.

FIG. 2 depicts a schematic view of an exemplary perishable product inventory control network configured to sell time-critical perishable goods and services.

FIG. 3 depicts a structural view of an exemplary mobile device adapted to collaborate with a cloud based software platform to sell time critical perishable goods quickly and cost effectively.

FIG. 4 depicts a structural view of an exemplary computing device configured to collaborate as an agent with a cloud based software platform to sell time critical perishable goods quickly and cost effectively.

FIG. 5 depicts a structural view of an exemplary computing device configured as a cloud-based transaction platform adapted to collaborate with sellers and buyers and coordinate transactions to sell time critical perishable goods quickly and cost effectively.

FIG. 6 depicts a structural view of an exemplary mobile device adapted to collaborate with a cloud based software platform to buy time critical perishable goods quickly and cost effectively.

FIG. 7 depicts a process flow of an exemplary PPSE (Perishable Product Seller Engine) collaborating with a cloud based software platform to sell time critical perishable goods quickly and cost effectively.

FIG. 8 depicts a process flow of an exemplary Perishable Product Platform Agent Engine (PPPAE) collaborating as an agent with a cloud based software platform to sell time critical perishable goods quickly and cost effectively.

FIG. 9 depicts a process flow of an exemplary Perishable Product Transaction Platform Engine (PPTPE) collaborating with sellers and buyers and coordinating transactions as a cloud based software platform to sell time critical perishable goods quickly and cost effectively.

FIG. 10 depicts a process flow of an exemplary PPBE (Perishable Product Buyer Engine) collaborating with a cloud based software platform to buy time critical perishable goods quickly and cost effectively.

FIG. 11 depicts an illustrative collaboration view of an exemplary cloud based software platform configured to sell a merchant's time critical perishable goods.

Like reference symbols in the various drawings indicate like elements.

### DETAILED DESCRIPTION OF ILLUSTRATIVE EMBODIMENTS

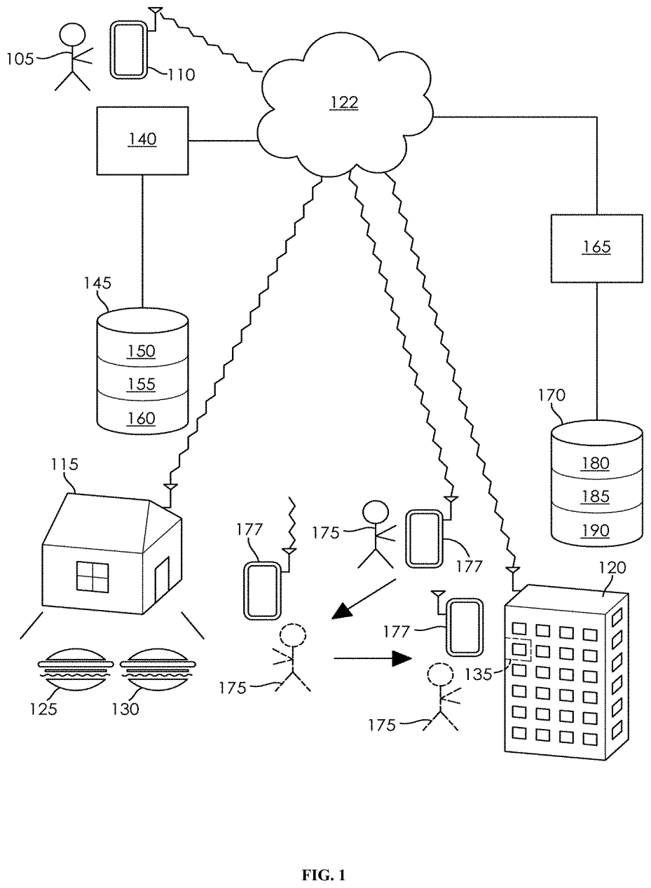

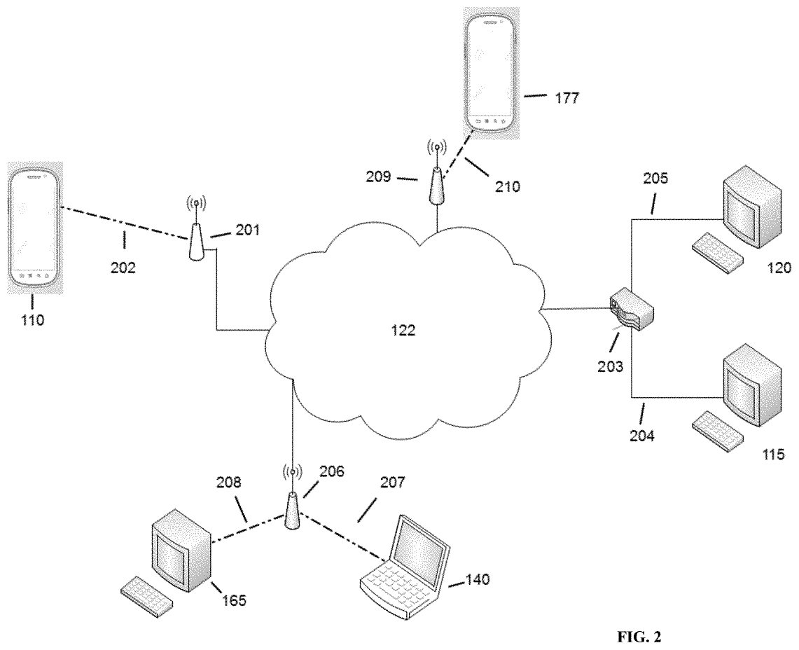

To aid understanding, this document is organized as follows. First, predicting a perishable product surplus quantity, associating the predicted product surplus to a shopper, and, automatically offering the shopper a discounted product surplus portion, is briefly introduced with reference to FIG. 1. Then, with reference to FIGS. 2-11, the discussion turns to exemplary embodiments that illustrate automatically offering the shopper a discounted product surplus portion predicted at a location and time determined as a function of product expiration time. Specifically, embodiment systems and methods illustrating automatically offering a discounted product surplus predicted at a location and time to a shopper, from platform, seller, buyer, and agent perspectives, are disclosed.

FIG. 1 depicts an exemplary operational scenario illustrative of an embodiment collaboration network configured with a perishable product inventory control system adapted to predict a perishable product surplus quantity at a location and time determined as a function of product expiration time, associate the predicted product surplus to a shopper seeking the product at the predicted location and time, and, automatically offer the shopper a portion of the product surplus discounted as a function of the perishable product surplus expiration time. In FIG. 1, the seller 105 employs the mobile device 110 to manage business assets including the delicatessen 115 and the hotel 120. In the illustrated embodiment, the network cloud 122 communicatively and operably couples the mobile device 110 with the delicatessen 115 and the hotel 120. In the illustrated example, the mobile device 110 receives real-time business intelligence data from the delicatessen 115 and the hotel 120. In the depicted example, the real-time business intelligence data received by the mobile device 110 includes periodically updated inventory, expiration time, and location of delicatessen 115 and hotel 120 products and resources, in addition to the rate at which products are sold, consumed, or discarded. In the depicted example, the delicatessen 115 initially has an inventory of two sandwiches subject to disposal when a future expiration time is reached. In the illustrated example, the sandwich 125 was made the previous day and must be discarded at closing time unless sold, resulting in a business loss to the seller 105. In the depicted example, the sandwich 130 was made on the current day, and must be discarded at closing time the next day if not sold, resulting in a business loss to the seller 105. In some exemplary scenarios, the delicatessen 115 may represent multiple delicatessens at various locations. In the illustrated example, the hotel 120 has a vacant room 135 available for rent. In an illustrative example, the seller 105 will not earn revenue from the vacant room 135 unless the room 135 is rented before midnight. In some exemplary scenarios, the hotel 120 may represent multiple hotels at various locations. In the depicted embodiment the seller agent 140 is communicatively and operably coupled with the network cloud 122. In the illustrated example, the seller agent 140 may send a query to the seller 105 to establish the seller agent 140 interest and availability to promote seller 105 goods and services. In the illustrated embodiment, the seller 105 mobile device 110 may collaborate with the seller agent 140 to market the perishable delicatessen 115 and hotel 120 business inventory assets, with goals including selling the perishable goods and services before they expire. In the illustrated example, the seller 105 and seller agent 140 negotiate pricing parameters governing the revenue the seller 105 will receive from the seller agent 140 for the seller 105 goods and services sold by the seller agent 140. In the depicted example, the seller 105 and seller agent 140 also negotiate fee parameters governing the fee the seller 105 will pay the seller agent 140 if the goods or services are sold by the seller agent 140. In the illustrated embodiment, the seller agent 140 and the seller 105 negotiate an agreement permitting the seller agent to sell the seller 105 goods and services at any selling price as long as the seller 105 receives the negotiated revenue from the seller agent 140 when the goods and services are sold. In the depicted embodiment, the seller 105 provides the seller agent 140 with periodically updated delicatessen 115 and hotel 120 business intelligence data including product inventory level, and the rate at which products are sold, consumed, or discarded. In the depicted example, the seller agent 140 is communicatively and operably coupled with the seller agent database 145. In the illustrated embodiment, the seller agent database 145 includes the product inventory records 150. In the depicted embodiment, the seller agent database 145 includes the product expiration time records 155. In the illustrated embodiment, the seller agent database 145 includes the product location records 160. In the illustrated embodiment, the seller agent 140 stores in the seller agent 140 database 145 product inventory records 150 the periodically updated delicatessen 115 sandwich 125 and sandwich 130 product inventory data received from the mobile device 110. In the illustrated embodiment, the seller agent 140 stores in the seller agent 140 database 145 product expiration time records 155 the periodically updated delicatessen 115 sandwich 125 and sandwich 130 expiration time data received from the mobile device 110. In the illustrated embodiment, the seller agent 140 stores in the seller agent database 145 product location records 160 the periodically updated delicatessen 115 sandwich 125 and sandwich 130 product locations received from the mobile device 110. In the illustrated embodiment, the seller agent 140 stores periodically updated hotel 120 room 135 product inventory data received from the mobile device 110 in the seller agent 140 database 145 product inventory records 150. In the illustrated embodiment, the seller agent 140 stores periodically updated hotel 120 vacant room 135 expiration time data received from the mobile device 110 in the seller agent 140 database 145 product expiration time records 155. In the illustrated embodiment, the seller agent 140 stores periodically updated hotel 120 vacant room 135 product locations received from the mobile device 110 in the seller agent database 145 product location records 160. In the illustrated embodiment, the perishable product inventory control system 165 is communicatively and operably coupled with the network cloud 122. In the depicted example, the seller agent 140 sends the seller 105 delicatessen 115 and hotel 120 business intelligence data to the perishable product inventory control system 165. In the illustrated example, the seller agent 140 includes with the seller 105 business intelligence data a request for the perishable product inventory control system 165 to market seller 105 perishable goods and services including the sandwich 125, the sandwich 130, and the vacant room 135. In the depicted embodiment, the perishable product inventory control system 165 is communicatively and operably coupled with the perishable product inventory control system database 170. In the illustrated example, the shopper 175 employs the mobile device 177 to create an account and register the shopper 175 interest in goods and services with the perishable product inventory control system 165. In the depicted embodiment, the shopper 175 account with the perishable product inventory control system 165 may include shopper 175 account data sent by the mobile device 177, such as, for example, shopper 175 account access credentials, name, address, and payment information. In an illustrative example, the perishable product inventory control system 165 may store the shopper 175 account data in the perishable product inventory control system database 170 customer account data 180 records. In the illustrated embodiment, the shopper 175 also employs the mobile device 177 to provide the perishable product inventory control system 165 with identification of products or product types the shopper 175 may be interested in purchasing. In the depicted embodiment, the shopper 175 also employs the mobile device 175 to provide the perishable product inventory control system 165 with the shopper 175 preferred price, location, or time at which the shopper would like to purchase the goods, services, or products of interest to the shopper 175. In some embodiments, the shopper 175 may employ the mobile device 177 to register to receive alerts triggered from the perishable product inventory control system 165 when goods or services are offered at price thresholds determined by the shopper 175. In various examples, alerts sent to the mobile device 177 may be triggered by the perishable product inventory control system 165 based on the location, time, product type, or price of a product offered for sale. In an illustrative example, the perishable product inventory control system 165 may store the shopper 175 preferred product, price, location, and time received from the mobile device 177 in the perishable product inventory control system database 170 customer preference data 185 records. In the depicted embodiment, the mobile device 177 periodically provides updates to the perishable product inventory control system 165 including periodically updated shopper 175 location data. In the illustrated embodiment, the perishable product inventory control system 165 stores the periodically updated shopper 175 location data received from the mobile device 177 in the perishable product inventory control system database 170 customer location 190 records. In the depicted embodiment, the perishable product inventory control system 165 predicts future inventory levels at the delicatessen 115 and the hotel 120 based on the business intelligence information periodically updated by the seller 105 mobile device 110. In some embodiments, the perishable product inventory control system 165 may predict a future product inventory surplus determined as a function of the real time business intelligence data based on a predictive model adapted from the fields of queueing theory or operations research. For example, some queueing theory models predict service times, queue lengths, arrival rates, and utilization rates. In various examples, some queueing theory models may be adapted to predict time-varying surplus probabilities by considering available business assets such as sandwiches and hotel rooms as, for example, servers in various queueing models. In the illustrated example, the perishable product inventory control system 165 determines there will be a perishable product surplus of one sandwich 125 at the delicatessen 115 current day closing time. In the depicted embodiment, the shopper 175 has registered with the perishable product inventory control system 165 an interest in purchasing a discounted sandwich. In the depicted embodiment, the shopper 175 has registered to receive an alert when products of interest are available for purchase within a predetermined radius of the shopper 175 location. In the illustrated embodiment, the perishable product inventory control system 165 determines the shopper 175 location is within the alert radius predetermined by the shopper 175. In the depicted embodiment, the perishable product inventory control system 165 associates the predicted product surplus sandwich 125 to the shopper 175 and automatically offers the shopper 175 the sandwich 125 at 80% off the regular selling price, calculated as a function of the time remaining to the sandwich 125 expiration time of the current day delicatessen 115 closing time. In the illustrated embodiment, the perishable product inventory control system 165 also offers shopper 175 the sandwich 130 at 100% of the regular selling price, at the current time. In various embodiments, the offer price of a product may be determined by the perishable product inventory control system 165 as a linear function of the perishable product surplus expiration time. For example, the product offer price may be incrementally discounted by a percentage reduction from the selling price. In an illustrative example, if the offer price is 100% of the regular selling price twenty-four hours from the expiration time, the offer price may be reduced by five percent of the regular selling price each hour, until the offer price reaches a predetermined business loss limit threshold. In the depicted example, the perishable product inventory control system 165 determines there will be a perishable product surplus of one hotel room 135 at the hotel 120 at midnight. In the depicted embodiment, the shopper 175 has registered with the perishable product inventory control system 165 an interest in renting a discounted hotel room. In the illustrated embodiment, the perishable product inventory control system 165 offers the shopper 175 the hotel room 135 at 50% off the regular selling price, based on the time of day and the time remaining until the vacant hotel room 135 expiration time of midnight the current day. In the depicted embodiment, the shopper 175 accepts the sandwich 125 and hotel room 135 offers, completing the purchases using stored payment information, through the perishable product inventory control system 165. In the illustrated example, the perishable product inventory control system 165 directs the shopper 175 to the delicatessen 115, to pick up the sandwich 125, and to the hotel 120, to take occupancy in the room 135.

FIG. 2 depicts a schematic view of an exemplary perishable product inventory control network configured to sell time-critical perishable goods and services. In FIG. 2, according to an exemplary embodiment of the present disclosure, data may be transferred to the system, stored by the system and/or transferred by the system to users of the system across local area networks (LANs) or wide area networks (WANs). In accordance with various embodiments, the system may be comprised of numerous servers, data mining hardware, computing devices, or any combination thereof, communicatively connected across one or more LANs and/or WANs. One of ordinary skill in the art would appreciate that there are numerous manners in which the system could be configured, and embodiments of the present disclosure are contemplated for use with any configuration. Referring to FIG. 2, a schematic overview of a system in accordance with an embodiment of the present disclosure is shown. In the depicted embodiment, an exemplary system includes the exemplary computing device 110 configured to enable the seller 105, depicted in FIG. 1, to collaborate with the seller agent 140 and the perishable product inventory control system 165 to sell goods and services. In the depicted example, the computing device 110 is a smart phone. In an illustrative example, exemplary collaboration between the computing device 110, the seller agent 140, and the perishable product inventory control system 165 may facilitate the sale of time-critical perishable goods via the exemplary computing device 177 employed by the shopper 175, depicted in FIG. 1. In the illustrated example, the computing device 177 is a smart phone. In the illustrated embodiment, the device 110 is communicatively and operably coupled by the wireless access point 201 and the wireless link 202 with the network cloud 122 (e.g., the Internet) to send, retrieve, or manipulate information in storage devices, servers, and network components, and exchange information with various other systems and devices via the network cloud 122. In the depicted example, the illustrative system includes the router 203 configured to communicatively and operably couple the delicatessen 115 to the network cloud 122 via the communication link 204. In the illustrated example, the router 203 also communicatively and operably couples the hotel 120 to the network cloud 122 via the communication link 205. In the depicted embodiment, the seller agent 140 is communicatively and operably coupled with the network cloud 122 by the wireless access point 206 and the wireless communication link 207. In the illustrated embodiment, the perishable product inventory control system 165 is communicatively and operably coupled with the network cloud 122 by the wireless access point 206 and the wireless communication link 208. In the depicted embodiment, the wireless access point 209 wireless communication link 210 communicatively and operably couples the network cloud with the mobile computing device 177 employed by the shopper 175, depicted in FIG. 1. In various examples, one or more of the computing device 110, seller agent 140, perishable product inventory control system 165, or mobile device 177 may include an application server configured to store or provide access to information used by the system. In various embodiments, one or more application server may retrieve or manipulate information in storage devices and exchange information through the network cloud 122. In some examples, one or more of the computing device 110, seller agent 140, perishable product inventory control system 165, or mobile device 177 may include various applications implemented as processor-executable program instructions. In some embodiments, various processor-executable program instruction applications may also be used to manipulate information stored remotely and process and analyze data stored remotely across the network cloud 122 (e.g., the Internet). According to an exemplary embodiment, as shown in FIG. 2, exchange of information through the network cloud 122 or other network may occur through one or more high speed connections. In some cases, high speed connections may be over-the-air (OTA), passed through networked systems, directly connected to one or more network cloud 122 or directed through one or more router. In various implementations, one or more router may be optional, and other embodiments in accordance with the present disclosure may or may not utilize one or more router. One of ordinary skill in the art would appreciate that there are numerous ways any or all of the depicted devices may connect with the network cloud 122 for the exchange of information, and embodiments of the present disclosure are contemplated for use with any method for connecting to networks for the purpose of exchanging information. Further, while this application may refer to high speed connections, embodiments of the present disclosure may be utilized with connections of any speed. In an illustrative example, components or modules of the system may connect to one or more of the computing device 110, seller agent 140, perishable product inventory control system 165, or mobile device 177 via the network cloud 122 or other network in numerous ways. For instance, a component or module may connect to the system i) through a computing device directly connected to the network cloud 122, ii) through a computing device connected to the network cloud 122 through a routing device, or iii) through a computing device connected to a wireless access point. One of ordinary skill in the art will appreciate that there are numerous ways that a component or module may connect to a device via network cloud 122 or other network, and embodiments of the present disclosure are contemplated for use with any network connection method. In various examples, one or more of the computing device 110, seller agent 140, perishable product inventory control system 165, or mobile device 177 could be comprised of a personal computing device, such as a smartphone, tablet computer, wearable computing device, cloud-based computing device, virtual computing device, or desktop computing device, configured to operate as a host for other computing devices to connect to. In some examples, one or more communications means of the system may be any circuitry or other means for communicating data over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

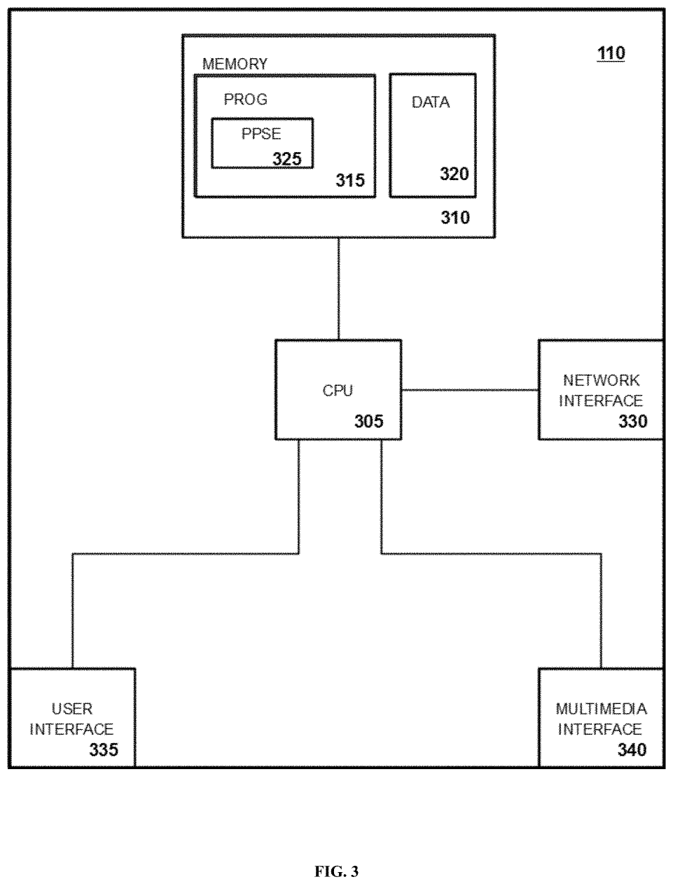

FIG. 3 depicts a structural view of an exemplary mobile device adapted to collaborate with a cloud based software platform to sell time critical perishable goods quickly and cost effectively. In FIG. 3, the block diagram of the exemplary mobile device 110 includes processor 305 and memory 310. The processor 305 is in electrical communication with the memory 310. The depicted memory 310 includes program memory 315 and data memory 320. The depicted program memory 315 includes processor-executable program instructions implementing the Perishable Product Seller Engine (PPSE) 325. In some embodiments, the illustrated program memory 315 may include processor-executable program instructions configured to implement an OS (Operating System). In various embodiments, the OS may include processor executable program instructions configured to implement various operations when executed by the processor 305. In some embodiments, the OS may be omitted. In some embodiments, the illustrated program memory 315 may include processor-executable program instructions configured to implement various Application Software. In various embodiments, the Application Software may include processor executable program instructions configured to implement various operations when executed by the processor 305. In some embodiments, the Application Software may be omitted. In the depicted embodiment, the processor 305 is communicatively and operably coupled with the network interface 330. In various implementations, the network interface may be a wireless network interface. In some designs, the network interface may be a Wi-Fi interface. In some embodiments, the network interface may be a Bluetooth interface. In an illustrative example, the mobile device 110 may include more than one network interface. In some designs, the network interface may be a wireline interface. In some designs, the network interface may be omitted. In the depicted embodiment, the processor 305 is communicatively and operably coupled with the user interface 335. In various implementations, the user interface 335 may be adapted to receive input from a user or send output to a user. In some embodiments, the user interface 335 may be adapted to an input-only or output-only user interface mode. In various implementations, the user interface 335 may include an imaging display. In some embodiments, the user interface 335 may include an audio interface. In some designs, the audio interface may include an audio input. In various designs, the audio interface may include an audio output. In some implementations, the user interface 335 may be touch-sensitive. In some designs, the mobile device 110 may include an accelerometer operably coupled with the processor 305. In various embodiments, the mobile device 110 may include a GPS module operably coupled with the processor 305. In an illustrative example, the mobile device 110 may include a magnetometer operably coupled with the processor 305. In some embodiments, some or all parts of an exemplary mobile device 110 system may be included within a client device, such that the functionalities could operate in a distributed manner. In some embodiments, the user interface 335 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 310 may contain processor executable program instruction modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 310 may contain processor executable program instruction modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In the depicted embodiment, the processor 305 is communicatively and operably coupled with the multimedia interface 340. In the illustrated embodiment, the multimedia interface 340 includes interfaces adapted to input and output of audio, video, and image data. In some embodiments, the multimedia interface 340 may include one or more still image camera or video camera. In various designs, the multimedia interface 340 may include one or more microphone. In some implementations, the multimedia interface 340 may include a wireless communication means configured to operably and communicatively couple the multimedia interface 340 with a multimedia data source or sink external to the mobile device 110. In various designs, the multimedia interface 340 may include interfaces adapted to send, receive, or process encoded audio or video. In various embodiments, the multimedia interface 340 may include one or more video, image, or audio encoder. In various designs, the multimedia interface 340 may include one or more video, image, or audio decoder. In various implementations, the multimedia interface 340 may include interfaces adapted to send, receive, or process one or more multimedia stream. In various implementations, the multimedia interface 340 may include a GPU. In some embodiments, the multimedia interface 340 may be omitted. Useful examples of the illustrated mobile device 110 include, but are not limited to, personal computers, servers, tablet PCs, smartphones, or other computing devices. In some embodiments, multiple mobile devices 110 may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary mobile device 110 design may be realized in a distributed implementation. In an illustrative example, some mobile device 110 designs may be partitioned between a client device, such as, for example, a phone, and, a more powerful server system, configured, for example, in a network such as depicted in FIG. 2. In various designs, a mobile device 110 partition hosted on a PC or mobile device may choose to delegate some parts of computation, such as, for example, machine learning or deep learning, to a mobile device 110 host server. In some embodiments, a client mobile device 110 partition may delegate computation-intensive tasks to a mobile device 110 host server to take advantage of a more powerful processor, or to offload excess work. In an illustrative example, some mobile devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some mobile device 110 features. However, in some embodiments, an exemplary mobile device 110 may be configured to operate on device with less processing power, such as, for example, various gaming consoles or phones, which may not have sufficient processor power, or a suitable CPU architecture, to adequately support mobile device 110. Various embodiment mobile device 110 designs configured to operate on a such a device with reduced processor power may work in conjunction with a more powerful mobile device 110 server system.

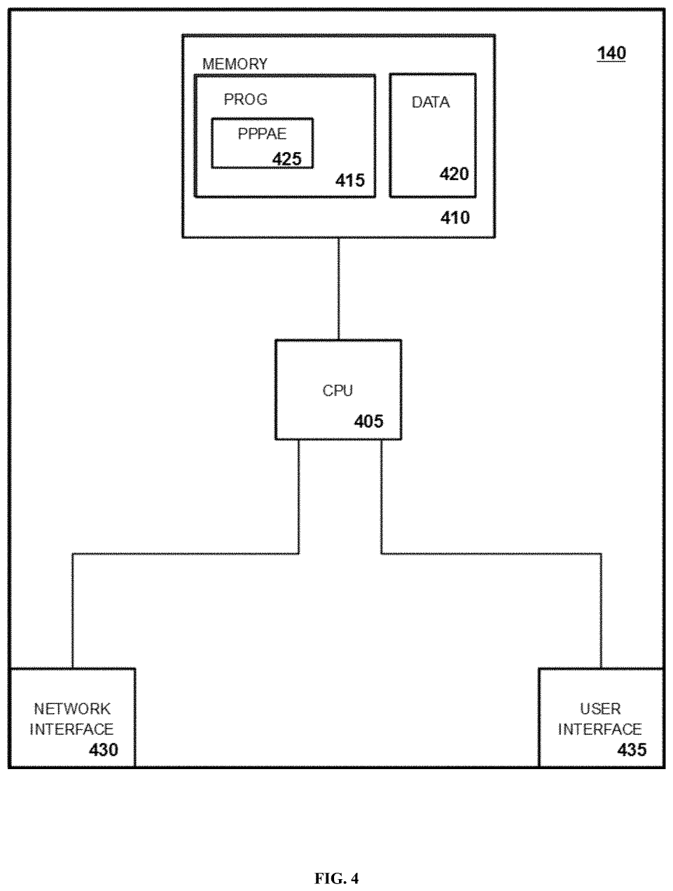

FIG. 4 depicts a structural view of an exemplary computing device configured to collaborate as an agent with a cloud based software platform to sell time critical perishable goods quickly and cost effectively. In FIG. 4, the block diagram of the exemplary agent computing device 140 includes processor 405 and memory 410. The processor 405 is in electrical communication with the memory 410. The depicted memory 410 includes program memory 415 and data memory 420. The depicted program memory 415 includes processor-executable program instructions implementing the Perishable Product Platform Agent Engine (PPPAE) 425. In some embodiments, the illustrated program memory 415 may include processor-executable program instructions configured to implement an OS (Operating System). In various embodiments, the OS may include processor executable program instructions configured to implement various operations when executed by the processor 405. In some embodiments, the OS may be omitted. In some embodiments, the illustrated program memory 415 may include processor-executable program instructions configured to implement various Application Software. In various embodiments, the Application Software may include processor executable program instructions configured to implement various operations when executed by the processor 405. In some embodiments, the Application Software may be omitted. In the depicted embodiment, the processor 405 is communicatively and operably coupled with the network interface 430. In various implementations, the network interface may be a wireless network interface. In some designs, the network interface may be a Wi-Fi interface. In some embodiments, the network interface may be a Bluetooth interface. In an illustrative example, the agent computing device 140 may include more than one network interface. In some designs, the network interface may be a wireline interface. In some designs, the network interface may be omitted. In the depicted embodiment, the processor 405 is communicatively and operably coupled with the user interface 435. In various implementations, the user interface 435 may be adapted to receive input from a user or send output to a user. In some embodiments, the user interface 435 may be adapted to an input-only or output-only user interface mode. In various implementations, the user interface 435 may include an imaging display. In some embodiments, the user interface 435 may include an audio interface. In some designs, the audio interface may include an audio input. In various designs, the audio interface may include an audio output. In some implementations, the user interface 435 may be touch-sensitive. In some designs, the agent computing device 140 may include an accelerometer operably coupled with the processor 405. In various embodiments, the computing device 140 may include a GPS module operably coupled with the processor 405. In an illustrative example, the computing device 140 may include a magnetometer operably coupled with the processor 405. In some embodiments, some or all parts of an exemplary agent computing device 140 system may be included within a client device, such that the functionalities could operate in a distributed manner. In some embodiments, the user interface 435 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 405 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 410 may contain processor executable program instruction modules configurable by the processor 405 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 405 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 410 may contain processor executable program instruction modules configurable by the processor 405 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. Useful examples of the illustrated agent computing device 140 include, but are not limited to, personal computers, servers, tablet PCs, smartphones, or other computing devices. In some embodiments, multiple agent computing devices 140 may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary agent computing device 140 design may be realized in a distributed implementation. In an illustrative example, some agent computing device 140 designs may be partitioned between a client device, such as, for example, a phone, and, a more powerful server system, configured, for example, in a network such as depicted in FIG. 2. In various designs, an agent computing device 140 partition hosted on a PC or mobile device may choose to delegate some parts of computation, such as, for example, machine learning or deep learning, to an agent computing device 140 host server. In some embodiments, a client agent computing device 140 partition may delegate computation-intensive tasks to an agent computing device 140 host server to take advantage of a more powerful processor, or to offload excess work. In an illustrative example, an embodiment agent computing device 140 may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some agent computing device 140 features. However, in some embodiments, an exemplary agent computing device 140 may be configured to operate on device with less processing power, such as, for example, various gaming consoles or phones, which may not have sufficient processor power, or a suitable CPU architecture, to adequately support agent computing device 140. Various embodiment agent computing device 140 designs configured to operate on a such a device with reduced processor power may work in conjunction with a more powerful agent computing device 140 server system.

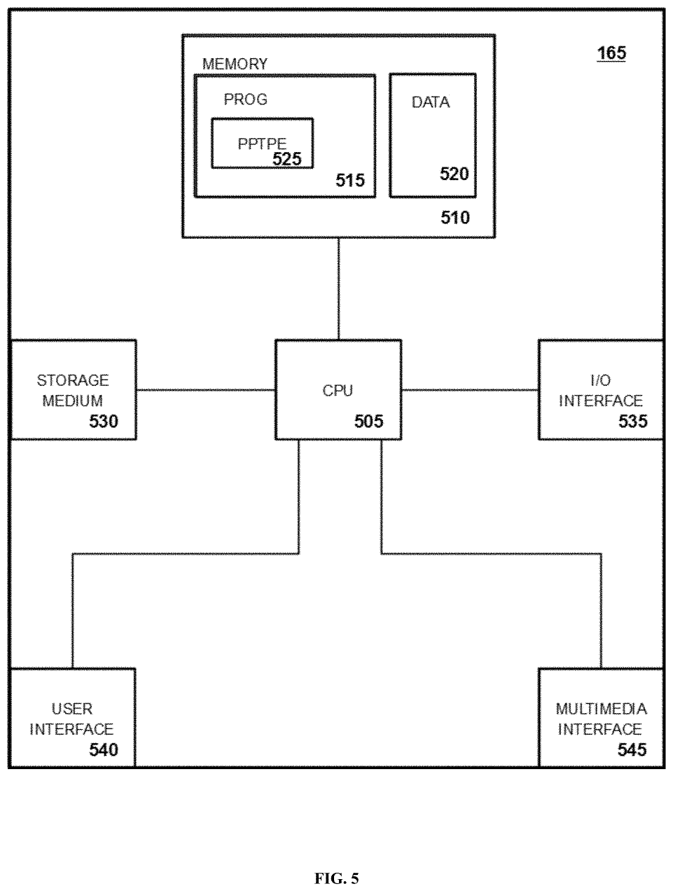

FIG. 5 depicts a structural view of an exemplary computing device configured as a cloud-based transaction platform adapted to collaborate with sellers and buyers and coordinate transactions to sell time critical perishable goods quickly and cost effectively. In FIG. 5, the block diagram of the exemplary perishable product transaction platform 165 includes processor 505 and memory 510. The processor 505 is in electrical communication with the memory 510. The depicted memory 510 includes program memory 515 and data memory 520. The depicted program memory 515 includes processor-executable program instructions implementing the Perishable Product Transaction Platform Engine (PPTPE) 525. In some embodiments, the illustrated program memory 515 may include processor-executable program instructions configured to implement an OS (Operating System). In various embodiments, the OS may include processor executable program instructions configured to implement various operations when executed by the processor 505. In some embodiments, the OS may be omitted. In some embodiments, the illustrated program memory 515 may include processor-executable program instructions configured to implement various Application Software. In various embodiments, the Application Software may include processor executable program instructions configured to implement various operations when executed by the processor 505. In some embodiments, the Application Software may be omitted. In the depicted embodiment, the processor 505 is communicatively and operably coupled with the storage medium 530. In various embodiment implementations, the storage medium 530 may encode program instructions, including program instructions executable by the processor 505, configured to implement any disclosed or depicted function. In the depicted embodiment, the processor 505 is communicatively and operably coupled with the I/O (Input/Output) Interface 535. In the depicted embodiment, the I/O Interface 535 includes a network interface. In various implementations, the network interface may be a wireless network interface. In some designs, the network interface may be a Wi-Fi interface. In some embodiments, the network interface may be a Bluetooth interface. In an illustrative example, the perishable product transaction platform 165 may include more than one network interface. In some designs, the network interface may be a wireline interface. In some designs, the network interface may be omitted. In the depicted embodiment, the processor 505 is communicatively and operably coupled with the user interface 540. In various implementations, the user interface 540 may be adapted to receive input from a user or send output to a user. In some embodiments, the user interface 540 may be adapted to an input-only or output-only user interface mode. In various implementations, the user interface 540 may include an imaging display. In some embodiments, the user interface 540 may include an audio interface. In some designs, the audio interface may include an audio input. In various designs, the audio interface may include an audio output. In some implementations, the user interface 540 may be touch-sensitive. In some designs, the perishable product transaction platform 165 may include an accelerometer operably coupled with the processor 505. In various embodiments, the perishable product transaction platform 165 may include a GPS module operably coupled with the processor 505. In an illustrative example, the perishable product transaction platform 165 may include a magnetometer operably coupled with the processor 505. In some embodiments, some or all parts of an exemplary perishable product transaction platform 165 system may be included within a client device, such that the functionalities could operate in a distributed manner. In some embodiments, the user interface 540 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 505 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 510 may contain processor executable program instruction modules configurable by the processor 505 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 505 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 510 may contain processor executable program instruction modules configurable by the processor 505 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In the depicted embodiment, the processor 505 is communicatively and operably coupled with the multimedia interface 545. In the illustrated embodiment, the multimedia interface 545 includes interfaces adapted to input and output of audio, video, and image data. In some embodiments, the multimedia interface 545 may include one or more still image camera or video camera. In various designs, the multimedia interface 545 may include one or more microphone. In some implementations, the multimedia interface 545 may include a wireless communication means configured to operably and communicatively couple the multimedia interface 545 with a multimedia data source or sink external to the perishable product transaction platform 165. In various designs, the multimedia interface 545 may include interfaces adapted to send, receive, or process encoded audio or video. In various embodiments, the multimedia interface 545 may include one or more video, image, or audio encoder. In various designs, the multimedia interface 545 may include one or more video, image, or audio decoder. In various implementations, the multimedia interface 545 may include interfaces adapted to send, receive, or process one or more multimedia stream. In various implementations, the multimedia interface 545 may include a GPU. In some embodiments, the multimedia interface 545 may be omitted. Useful examples of the illustrated perishable product transaction platform 165 include, but are not limited to, personal computers, servers, tablet PCs, smartphones, or other computing devices. In some embodiments, multiple perishable product transaction platform 165 devices may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary perishable product transaction platform 165 design may be realized in a distributed implementation. In an illustrative example, some perishable product transaction platform 165 designs may be partitioned between a client device, such as, for example, a phone, and, a more powerful server system, such as depicted in FIG. 2. In various designs, a perishable product transaction platform 165 partition hosted on a PC or mobile device may choose to delegate some parts of computation, such as, for example, machine learning or deep learning, to a perishable product transaction platform 165 host server. In some embodiments, a client device perishable product transaction platform 165 partition may delegate computation-intensive tasks to a perishable product transaction platform 165 host server to take advantage of a more powerful processor, or to offload excess work. In an illustrative example, some perishable product transaction platform 165 devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some perishable product transaction platform 165 features. However, in some embodiments, an exemplary perishable product transaction platform 165 may be configured to operate on device with less processing power, such as, for example, various gaming consoles or phones, which may not have sufficient processor power, or a suitable CPU architecture, to adequately support perishable product transaction platform 165. Various embodiment perishable product transaction platform 165 designs configured to operate on a such a device with reduced processor power may work in conjunction with a more powerful perishable product transaction platform 165 server system.

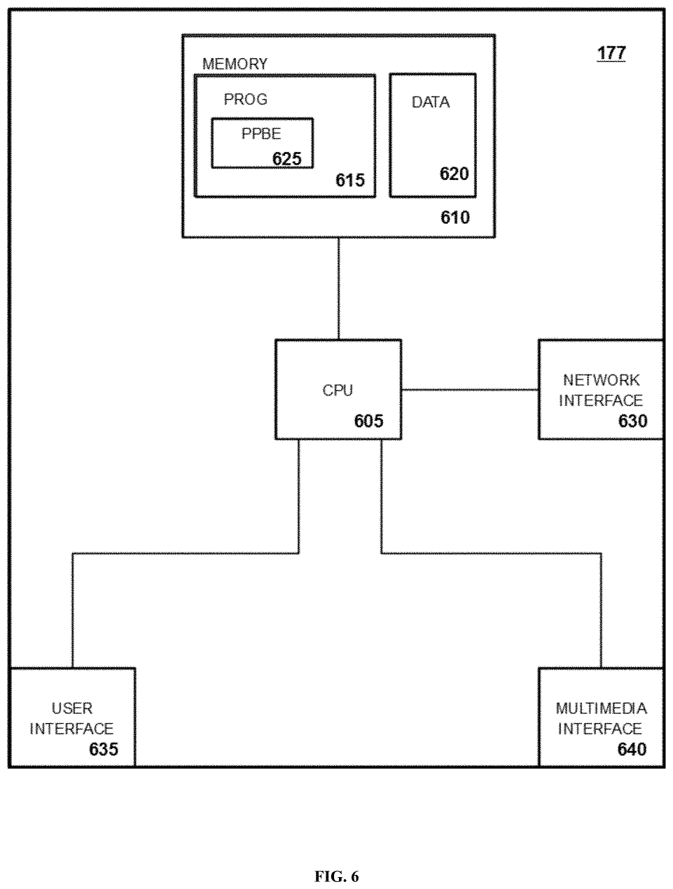

FIG. 6 depicts a structural view of an exemplary mobile device adapted to collaborate with a cloud based software platform to buy time critical perishable goods quickly and cost effectively. In FIG. 6, the block diagram of the exemplary mobile device 177 includes processor 605 and memory 610. The processor 605 is in electrical communication with the memory 610. The depicted memory 610 includes program memory 615 and data memory 620. The depicted program memory 615 includes processor-executable program instructions implementing the Perishable Product Buyer Engine (PPBE) 625. In some embodiments, the illustrated program memory 615 may include processor-executable program instructions configured to implement an OS (Operating System). In various embodiments, the OS may include processor executable program instructions configured to implement various operations when executed by the processor 605. In some embodiments, the OS may be omitted. In some embodiments, the illustrated program memory 615 may include processor-executable program instructions configured to implement various Application Software. In various embodiments, the Application Software may include processor executable program instructions configured to implement various operations when executed by the processor 605. In some embodiments, the Application Software may be omitted. In the depicted embodiment, the processor 605 is communicatively and operably coupled with the network interface 630. In various implementations, the network interface may be a wireless network interface. In some designs, the network interface may be a Wi-Fi interface. In some embodiments, the network interface may be a Bluetooth interface. In an illustrative example, the mobile device 177 may include more than one network interface. In some designs, the network interface may be a wireline interface. In some designs, the network interface may be omitted. In the depicted embodiment, the processor 605 is communicatively and operably coupled with the user interface 635. In various implementations, the user interface 635 may be adapted to receive input from a user or send output to a user. In some embodiments, the user interface 635 may be adapted to an input-only or output-only user interface mode. In various implementations, the user interface 635 may include an imaging display. In some embodiments, the user interface 635 may include an audio interface. In some designs, the audio interface may include an audio input. In various designs, the audio interface may include an audio output. In some implementations, the user interface 635 may be touch-sensitive. In some designs, the mobile device 177 may include an accelerometer operably coupled with the processor 605. In various embodiments, the mobile device 177 may include a GPS module operably coupled with the processor 605. In an illustrative example, the mobile device 177 may include a magnetometer operably coupled with the processor 605. In some embodiments, some or all parts of an exemplary mobile device 177 system may be included within a client device, such that the functionalities could operate in a distributed manner. In some embodiments, the user interface 635 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 605 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 610 may contain processor executable program instruction modules configurable by the processor 605 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 605 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 610 may contain processor executable program instruction modules configurable by the processor 605 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In the depicted embodiment, the processor 605 is communicatively and operably coupled with the multimedia interface 640. In the illustrated embodiment, the multimedia interface 640 includes interfaces adapted to input and output of audio, video, and image data. In some embodiments, the multimedia interface 640 may include one or more still image camera or video camera. In various designs, the multimedia interface 640 may include one or more microphone. In some implementations, the multimedia interface 640 may include a wireless communication means configured to operably and communicatively couple the multimedia interface 640 with a multimedia data source or sink external to the mobile device 177. In various designs, the multimedia interface 640 may include interfaces adapted to send, receive, or process encoded audio or video. In various embodiments, the multimedia interface 640 may include one or more video, image, or audio encoder. In various designs, the multimedia interface 640 may include one or more video, image, or audio decoder. In various implementations, the multimedia interface 640 may include interfaces adapted to send, receive, or process one or more multimedia stream. In various implementations, the multimedia interface 640 may include a GPU. In some embodiments, the multimedia interface 640 may be omitted. Useful examples of the illustrated mobile device 177 include, but are not limited to, personal computers, servers, tablet PCs, smartphones, or other computing devices. In some embodiments, multiple mobile devices 177 may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary mobile device 177 design may be realized in a distributed implementation. In an illustrative example, some mobile device 177 designs may be partitioned between a client device, such as, for example, a phone, and, a more powerful server system, configured, for example, in a network such as depicted in FIG. 2. In various designs, a mobile device 177 partition hosted on a PC or mobile device may choose to delegate some parts of computation, such as, for example, machine learning or deep learning, to a mobile device 177 host server. In some embodiments, a client mobile device 177 partition may delegate computation-intensive tasks to a mobile device 177 host server to take advantage of a more powerful processor, or to offload excess work. In an illustrative example, some mobile devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some mobile device 177 features. However, in some embodiments, an exemplary mobile device 177 may be configured to operate on device with less processing power, such as, for example, various gaming consoles or phones, which may not have sufficient processor power, or a suitable CPU architecture, to adequately support mobile device 177. Various embodiment mobile device 177 designs configured to operate on a such a device with reduced processor power may work in conjunction with a more powerful mobile device 177 server system.

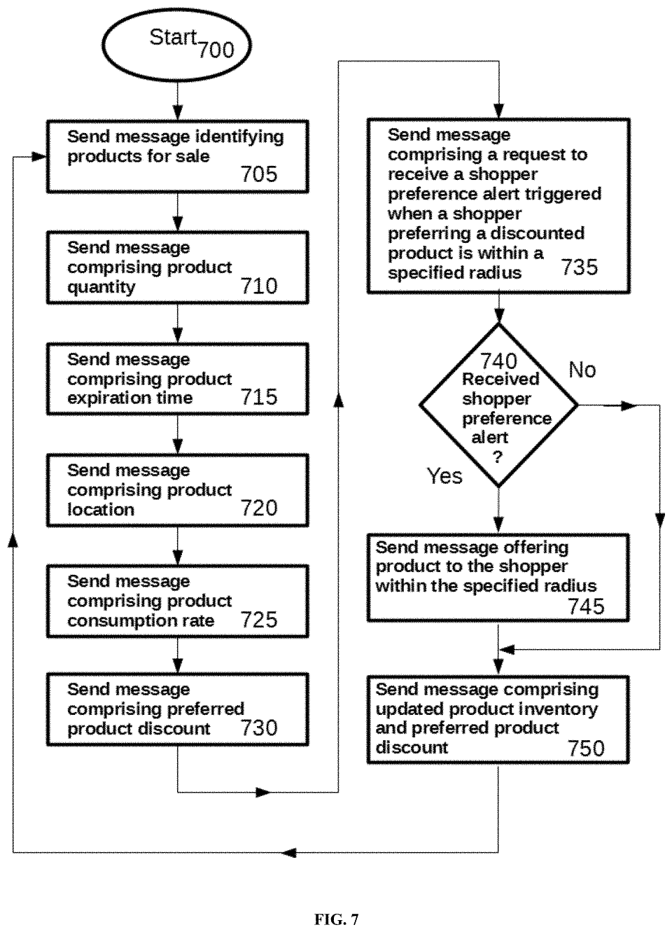

FIG. 7 depicts a process flow of an exemplary PPSE (Perishable Product Seller Engine) collaborating with a cloud based software platform to sell time critical perishable goods quickly and cost effectively. The method depicted in FIG. 7 is given from the perspective of the PPSE (Perishable Product Seller Engine) 325 executing as program instructions on the processor (CPU) 305, depicted in FIG. 3. In the illustrated embodiment, the PPSE 325 executes as program instructions on the processor 305 configured in the PPSE host mobile computing device 110, depicted in at least FIG. 1, FIG. 2, and FIG. 3. In some embodiments, the PPSE 325 may execute as a cloud service communicatively coupled with system services, hardware resources, or software elements local to and/or external to the PPSE host mobile device 110. The depicted method 700 begins at step 705 with the processor 305 sending an electronic message identifying products for sale. The method continues at step 710 with the processor 305 sending an electronic message comprising product quantity. The method continues at step 715 with the processor 305 sending an electronic message comprising product expiration time. The method continues at step 720 with the processor 305 sending an electronic message comprising product location. The method continues at step 725 with the processor 305 sending an electronic message comprising product consumption rate. The method continues at step 730 with the processor 305 sending an electronic message comprising preferred product discount. The method continues at step 735 with the processor 305 sending an electronic message comprising a request to receive a shopper preference alert triggered when a shopper preferring a discounted product is within a specified radius. The method continues at step 740 with the processor 305 performing a test to determine if the shopper preference alert was received. Upon a determination by the processor 305 at step 740 the shopper preference alert was received, the method continues at step 745 with the processor 305 sending an electronic message offering the product to the shopper within the specified radius. Upon a determination by the processor 305 at step 740 the shopper preference alert was not received, the method continues at step 750 with the processor 305 sending an electronic message comprising updated product inventory and preferred product discount, and the method continues at step 705 with the processor 305 sending an electronic message identifying products for sale.

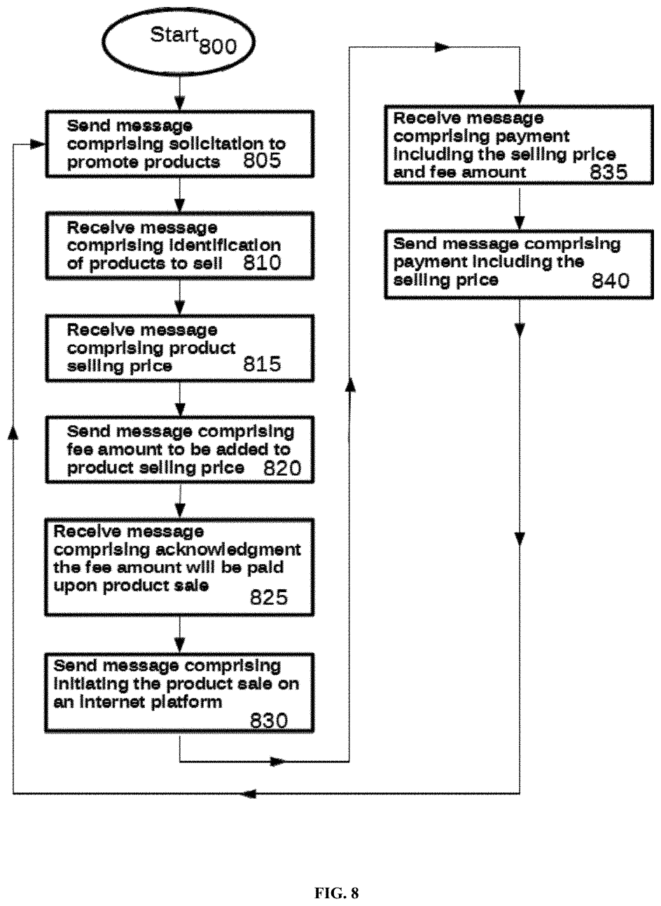

FIG. 8 depicts a process flow of an exemplary Perishable Product Platform Agent Engine (PPPAE) collaborating as an agent with a cloud based software platform to sell time critical perishable goods quickly and cost effectively. The method depicted in FIG. 8 is given from the perspective of the Perishable Product Platform Agent Engine (PPPAE) 425 executing as program instructions on the processor (CPU) 405, depicted in FIG. 4. In the illustrated embodiment, the PPPAE 425 executes as program instructions on the processor 405 configured in the PPPAE agent host computing device 140, depicted in at least FIG. 1, FIG. 2, and FIG. 4. In some embodiments, the PPPAE 425 may execute as a cloud service communicatively coupled with system services, hardware resources, or software elements local to and/or external to the PPPAE agent host computing device 140. The depicted method 800 begins at step 805 with the processor 405 sending an electronic message comprising a solicitation to promote products. The method continues at step 810 with the processor 405 sending an electronic message comprising identification of products to sell. The method continues at step 815 with the processor 405 receiving an electronic message comprising a product selling price. The method continues at step 820 with the processor 405 sending an electronic message comprising a fee amount to be added to the product selling price. The method continues at step 825 with the processor 405 receiving an electronic message comprising an acknowledgement the fee amount will be paid upon product sale. The method continues at step 830 with the processor 405 sending an electronic message comprising initiating the product sale on an Internet platform. The method continues at step 835 with the processor 405 receiving an electronic message comprising payment including the selling price and fee amount. The method continues at step 840 with the processor 405 sending an electronic message comprising payment including the selling price, and the method continues at step 805 with the processor 405 sending an electronic message comprising a solicitation to promote products.

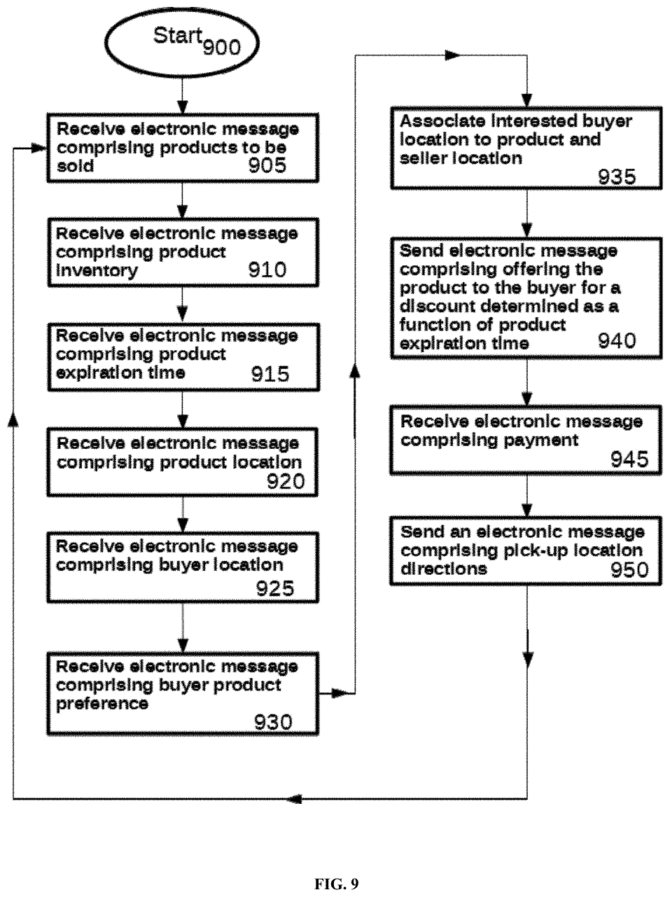

FIG. 9 depicts a process flow of an exemplary Perishable Product Transaction Platform Engine (PPTPE) collaborating with sellers and buyers and coordinating transactions as a cloud based software platform to sell time critical perishable goods quickly and cost effectively. The method depicted in FIG. 9 is given from the perspective of the Perishable Product Transaction Platform Engine (PPTPE) 525 executing as program instructions on the processor (CPU) 505, depicted in FIG. 5. In the illustrated embodiment, the PPTPE 525 executes as program instructions on the processor 505 configured in the PPTPE platform host computing device 165, depicted in at least FIG. 1, FIG. 2, and FIG. 5. In some embodiments, the PPTPE 525 may execute as a cloud service communicatively coupled with system services, hardware resources, or software elements local to and/or external to the PPTPE platform host computing device 165. The depicted method 900 begins at step 905 with the processor 505 receiving an electronic message comprising identification of products to be sold. The method continues at step 910 with the processor 505 receiving an electronic message comprising product inventory. The method continues at step 915 with the processor 505 receiving an electronic message comprising product expiration time. The method continues at step 920 with the processor 505 receiving an electronic message comprising product location. The method continues at step 925 with the processor 505 receiving an electronic message comprising buyer location. The method continues at step 930 with the processor 505 receiving an electronic message comprising buyer product preference. The method continues at step 935 with the processor 505 associating an interested buyer location to the product and seller location. The method continues at step 940 with the processor 505 sending an electronic message comprising offering the product to the buyer for a discount determined as a function of product expiration time. The method continues at step 945 with the processor 505 receiving an electronic message comprising payment. The method continues at step 950 with the processor 505 sending an electronic message comprising pick-up location directions, and the method continues at step 905 with the processor 505 receiving an electronic message comprising identification of products to be sold.

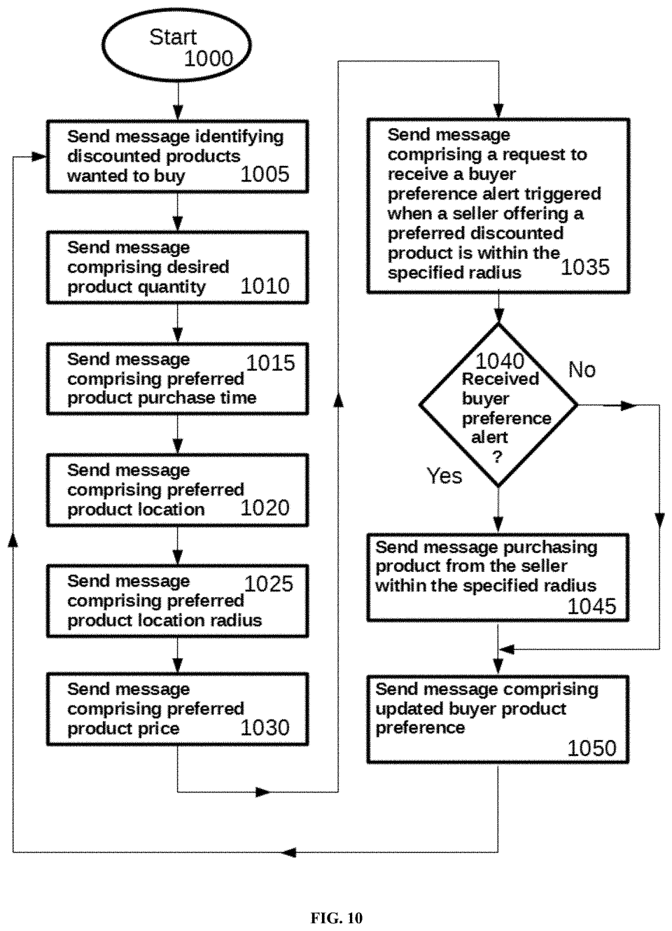

FIG. 10 depicts a process flow of an exemplary PPBE (Perishable Product Buyer Engine) collaborating with a cloud based software platform to buy time critical perishable goods quickly and cost effectively. The method depicted in FIG. 10 is given from the perspective of the PPBE (Perishable Product Buyer Engine) 625 executing as program instructions on the processor (CPU) 605, depicted in FIG. 6. In the illustrated embodiment, the PPBE 625 executes as program instructions on the processor 605 configured in the PPBE host mobile computing device 177, depicted in at least FIG. 1, FIG. 2, and FIG. 6. In some embodiments, the PPBE 625 may execute as a cloud service communicatively coupled with system services, hardware resources, or software elements local to and/or external to the PPBE host mobile computing device 177. The depicted method 1000 begins at step 1005 with the processor 605 sending an electronic message identifying discounted products wanted to buy. The method continues at step 1010 with the processor 605 sending an electronic message comprising the desired product quantity. The method continues at step 1015 with the processor 605 sending an electronic message comprising the preferred product purchase time. The method continues at step 1020 with the processor 605 sending an electronic message comprising the preferred product location. The method continues at step 1025 with the processor 605 sending an electronic message comprising the preferred product location radius. The method continues at step 1030 with the processor 605 sending an electronic message comprising the preferred product price. The method continues at step 1035 with the processor 605 sending an electronic message comprising a request to receive a buyer preference alert triggered when a seller offering a preferred discounted product is within the specified radius. At step 1040, the processor 605 performs a test to determine if the buyer preference alert was received. Upon a determination by the processor 605 at step 1040 the buyer preference alert was received, the method continues at step 1045 with the processor 605 sending an electronic message purchasing the product from the seller within the specified radius. Upon a determination by the processor 605 at step 1040 the buyer preference alert was not received, the method continues at step 1050 with the processor 605 sending an electronic message comprising updated buyer product preference, and the method continues at step 1005 with the processor 605 sending an electronic message identifying discounted products wanted to buy.

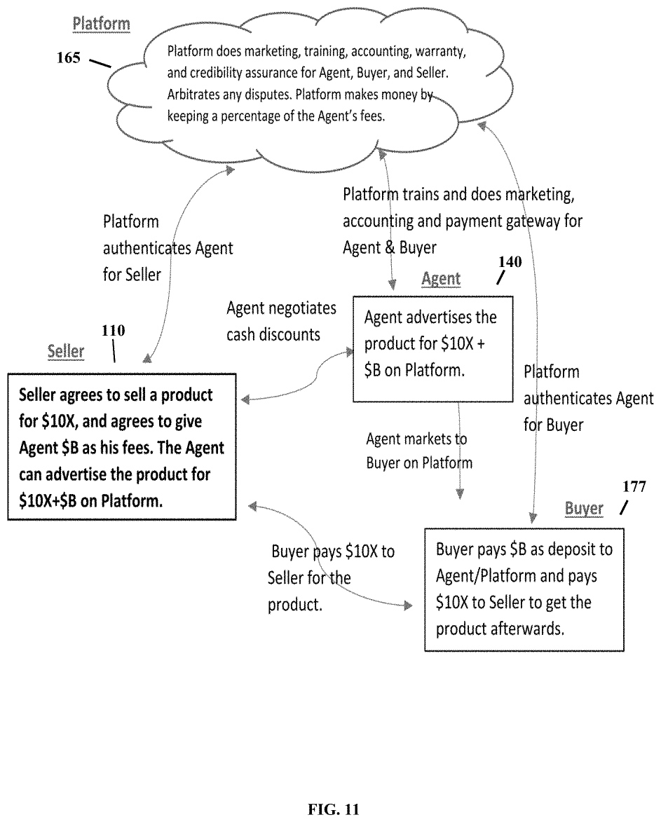

FIG. 11 depicts an illustrative collaboration view of an exemplary cloud based software platform configured to sell a merchant's time critical perishable goods. In FIG. 11, the illustrated seller computing device 110 acts in an exemplary Seller role. In the illustrated example, the depicted seller agent 140 acts in an exemplary Agent role. The perishable product inventory control system 165 is depicted acting in an exemplary Platform role. In the depicted example, the shopper mobile device 177 is illustrated in an exemplary Buyer role. In the illustrated embodiment, the Seller device 110, the Agent device 140, the Platform device 165, and the Buyer device 177 engage in exemplary collaborative transactions. The exemplary collaboration depicted in FIG. 11 illustrates exemplary roles of the various entities collaborating to sell time critical perishable goods. In an illustrative example, the Platform performs marketing, training, accounting, warranty, and credibility assurance for the Agent, Buyer, and Seller, and arbitrates any disputes. In the depicted embodiment, the Platform makes money by keeping a percentage of the Agent's fees. In the illustrated embodiment, the Platform authenticates the Agent for the Seller. In the depicted embodiment, the Platform also provides a payment gateway for the Agent and Buyer. In an illustrative example, the Seller agrees to sell a product for a predetermined selling price, for example, $10X, and agrees to give the Agent $B as the Agent's fee. In the depicted embodiment, the Agent can advertise the product for $10X+$B on the Platform. In the illustrated embodiment, the Agent negotiates cash discounts with the Seller. In the illustrated embodiment, the Platform authenticates the Agent for the Buyer. In the depicted embodiment, the Buyer pays $B as a deposit to the Agent/Platform. In the illustrated embodiment, the Buyer also pays $10X to the Seller for the product.

Although various embodiments have been described with reference to the Figures, other embodiments are possible. For example, various embodiment designs may include a business model having four players. In an illustrative example, the four players all work towards creating an economic value for themselves in a transaction. In some embodiments, the four players may take the roles of Seller, Agent, Buyer, and Platform. In various implementations, the Agent may obtain an agreement from the Seller to offer a discounted price for a product on the Platform. In some designs, the Seller may agree to give the Agent a service fee of $B upon a sale. In some embodiments, the Seller may agree to let the Agent set any value for $B. In an illustrative example, the Agent may advertise the Seller's product for $10X+$B on the Platform. In various designs, the Buyer may be told to pay $B in advance as a deposit before picking up the product. In some embodiments, the Buyer may pay the Seller $10X and get the product at the Seller's premises. In some examples, the Agent may keep the $B deposit as the Seller's fee payment. Various implementations may enable the Agent to allow the Platform to take a cut, for example $B, as Platform fees. In an example illustrative of various embodiments, the Platform may serve a unique role in providing credibility, assurance, accounting services, and mediation for Business, Agent, and Consumer. In various embodiment implementations, the Platform and Agent may be the same entity. Various embodiment implementations provide a business model that brings together four interested parties to a commercial transaction in such a manner that each contributes tangible and intangible assets that in aggregate they make the transaction more attractive for all the parties. In various examples illustrative of some business transactions, there may be buyers and sellers; in some scenarios, there may be additional facilitators, such as agents and service providers. In a well-constructed arrangement, the seller and buyer get the prices they want, and the facilitators get the fees the deserve. Ideally, the accounting should be simple, and the cash is immediately available to the recipients without further discounts and delays. We have presented a design and method to achieve this goal. For example, an agent may solicit a seller to promote the seller's products. In some scenarios, the seller may agree, and set a price he wants to sell a product for, say at $10X, instead of its normal price of $20X. In an illustrative example, the seller may further agree that if the product is sold, he shall pay a fee to the agent. In some examples, the seller may additionally agree that the agent can set the platform's selling price to anything he wants as long as the seller receives $10X, net of all fees, from the buyer, and the difference between the platform's price and $10X is the agent's fee. In some embodiments, the agent may put the product on an internet platform and set the price for the product at $10X+$B. In some exemplary scenarios, a buyer may decide to buy, and may be told that he has to put down a deposit of $B to reserve the product. In an illustrative scenario, when the buyer meets the seller, the buyer pays $10X to the seller and gets his product, and the agent keeps $B as his fee. In an illustrative example, the agent may remit a certain percentage of $B to the internet platform as service fees. Note that the agent and the platform can be the same party or two parties. Various embodiments provide a cloud based software platform for merchants to sell time critical perishable goods quickly and cost effectively. In some embodiments, exemplary platform implementations may bring buyers and sellers together to help the buyers to buy products at a discount and the sellers to sell products that would normally diminish or perish in values in a matter of hours. For example, a sandwich if not sold in late evening hours would rapidly diminish in value; the same goes for a hotel room after perhaps 9 pm each day. The benefits of various embodiment designs include putting more money in the hands of retail merchants and consumers. Some exemplary embodiment platform implementations allow retail merchants and consumers to meet in a very cost-efficient manner. In various exemplary scenarios, some small businesses face a challenging task each day to get rid of their over produced perishable inventories. The surplus inventory amounts may be very small and may not be worth the time and the expenses to run promotions; and, the time to react is very short before the product becomes unsellable. In various embodiment platform designs, a merchant with a small perishable inventory can quickly upload the product information and the minimum price desired, and the platform will find the most opportune buyers to look at the product. Once the product is sold, the platform will handle the back room accounting and direct the buyer to pick up the product from the merchant. Various embodiment platform examples may provide substantial benefits for the seller, including: No up-front membership cost, a seller may use the platform as needed; discounts are discreet; that is, the regular price structure does not get affected, such that most regular customers may never know some potential customer received a potentially deeply-discounted product or service; Able to reach certain customers normally not available to the merchant; Can serve as brand building; May turn a total loss when a product perishes, to a partial gain in revenue after discounting; and, a seller may rely on our platform as a trust provider to market their perishable products and collect payments from the new buyers.

Various embodiment platform examples may provide substantial benefits for the buyer, including: No up-front membership cost, a buyer may use the platform as needed; a buyer may be able to enjoy good products at a discount; a buyer may be able to patronize businesses who were previously not affordable; and, a buyer may rely on the platform as a trust provider to try new products and new merchants. Various embodiment designs may provide a means to help merchants in various ways. For example, some embodiments may enable merchants to sell their overproduced and perishable goods. In some scenarios, various embodiments may permit a merchant to sell overproduced and perishable goods without affecting their regular marketing and sales. In some designs, a merchant may be able to move very small quantities of perishable goods, for example, one sandwich or one hotel room, while avoiding costly marketing to move small amounts of perishable goods.

In various exemplary scenarios, some embodiments may provide a means to help consumers. For example, some embodiment designs may provide consumers with a secure platform to browse any special just-happened local offers from their local community. Some embodiments may provide a trust worthy platform for consumers to place orders for goods that are new to them, or to try quality goods at more affordable prices.

Various embodiment platform designs deal with perishable goods in terms of hours before the goods become worthless. In an illustrative example, exemplary scenarios illustrative of some embodiments' usage may market even small quantities in real-time; for example, marketing one sandwich or two slices of pizza. In various embodiment implementations, merchants may have no long-term commitments.

Various embodiment platform designs may find more goods and services that would fall into the perishable category. Perishable goods or services marketed and sold by an embodiment platform implementation may take various forms. For example, perishable goods or services may include food, or perishable space. For example, seating in a manicure or nail shop is perishable; the store manager should use an embodiment platform to offer a deep discount if a consumer would come in within a limited time, for example, within one hour. In various example scenarios, some hotel and hospitality resources or assets may be perishable.

In an illustrative example, some embodiment platform implementations may perform various tasks for a buyer, including:
Create an account for the buyer
Determine the buyer's physical location and match this to the available merchant offers within a certain radius preferred by the buyer
Check periodically about the available inventory from the merchant
Provide product info for the buyer to make a purchase decision
Provide product pick up instructions and conditions
Guarantee the product sold would be available
Collect payments and returns

In an illustrative example, some embodiment platform implementations may perform various tasks for a seller, including:
Let the merchant post products on our platform
Qualify the merchant for their reputation and history in business
Communicate with the merchant periodically about inventory availability
Inform the merchant about any product sold and pick-ups expected
Collect payments and disburse payments to the merchant
Handle returns and credits requests

In some exemplary scenarios, various embodiment platform implementations may be referred to as a ‘Manager Special’ platform. Some Manager Special designs may have various specialized characteristics, including, for example:
Limited Quantity: A merchant does not produce new goods for our buyers; instead, the merchant attempts to sell his overproduced perishable goods at discount to our buyers, to mitigate his loss
Limited Time: A merchant offers discounts on specific items for a limited time, bounded by an item expiration time; in some examples, the discount may be determined as a function of time remaining until an item's expiration time
Discreet: A merchant's regular customers do not have to know the discounts offered
Auto reprising setting: A merchant can for example configure a 30% discount starting at 4 pm, and automatically and progressively increasing the discount at an additional 10% off per hour until it is finally 60% off
Auto alert for buyers: a user can set auto alerts instructing the platform to look for any combination or all of:
   A specific or similar product, or
   In a specific or similar category or
   From a specific or similar merchant or
   At a given time period
Auto alerts for sellers: A seller can receive alerts telling him how many of the people are looking for products or services similar to what he offers in a particular time period and price range
Buyer's ability to set an alert for him when a certain price level for the product he wants is reached, for example, any buyer is able to set an alert to notify him when the price level for the product he is interested in is reached; for example, the buyer can indicate he would like to be notified when a product reached 50% off from a specific buyer, or any buyer, and for a specific product, or any similar product

Various embodiment implementations may provide substantial new benefits for a Seller. For example, some embodiments may enable a Seller to improve efficiency in a controlled, trusted, discreet, and zero up front cost method to attract new buyers. Some embodiment designs may provide significant new benefits to an Agent. For example, various embodiments may empower an Agent to become a business operator in a trusted relationship to monetize available time to serve as Agent to bring buyers and sellers together. Some embodiments provide valuable new benefits for a Buyer. In an illustrative example, various embodiment designs may provide a means for a Buyer in a trusted environment to enjoy discounted services and products. In various scenarios illustrative of some embodiment implementations' usage, a platform user or operator may enjoy various substantial new benefits, including, for example, providing for a platform operator to monetize the platform operator's service as a trust provider for Seller, Agent, and Buyer, to facilitate their transactions.

In various examples illustrative of some prior art usage scenarios, entities such as, for example, GroupOn or Yelp may provide platforms to bring merchants and buyers together, however such entities do not deal exclusively with merchants who have already over produced some perishable goods. They are more for longer-term brand building and bulk purchases. One significant distinction is that the merchant would normally increase production for the demand brought on by GroupOn and Yelp; whereas, in various scenarios exemplary of some embodiments of the present invention, the merchant may need the embodiment platform because they have already over produced some perishable goods.

In the Summary above and in this Detailed Description, and the Claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments, elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as may be described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f).

According to an embodiment of the present invention, the system and method may be accomplished through the use of one or more computing devices. As depicted, for example, at least in FIG. 1, FIG. 2, and FIG. 3, one of ordinary skill in the art would appreciate that an exemplary system appropriate for use with embodiments in accordance with the present application may generally include one or more of a Central processing Unit (CPU), Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description may set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a sequence of computational instructions or program instructions. It will be appreciated that a programmable apparatus (i.e., computing device) can receive such a computer program and, by processing the computational instructions thereof, produce a further technical effect.

A programmable apparatus may include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An apparatus, comprising:
a perishable product inventory control system configured to reduce product inventory with a product discounting action executed in response to a perishable product surplus predicted by the system, comprising:
a processor; and,
a memory that is not a transitory propagating signal, the memory operably coupled with the processor and encoding computer readable instructions, including processor executable program instructions, the computer readable instructions accessible to the processor, wherein the processor executable program instructions, when executed by the processor, cause the processor to perform operations comprising:
predict a perishable product surplus quantity at a location and time determined as a function of the product expiration time;
associate the predicted product surplus to a shopper seeking the product at the predicted location and time; and,
automatically offer the shopper a portion of the product surplus at a price discounted as a function of the perishable product surplus expiration time.

2. The apparatus of claim 1, wherein the operations performed by the processor further comprise receiving an electronic message comprising the product consumption rate.

3. The apparatus of claim 2, wherein the function of the product expiration time used to predict the perishable product surplus quantity further comprises a function of the product consumption rate.

4. The apparatus of claim 1, wherein the operations performed by the processor further comprise: in response to receiving an electronic message comprising a price threshold, configuring a discount price alert triggered as a function of comparing the discounted product surplus price to the price threshold.

5. The apparatus of claim 4, wherein the operations performed by the processor further comprise sending an electronic message comprising the discount price alert.

6. The apparatus of claim 1, wherein the discount determined as a function of the perishable product surplus expiration time further comprises the discount determined as a progressive function of increasing time.

7. The apparatus of claim 1, wherein the operations performed by the processor further comprise receiving an electronic message comprising the shopper location.

8. The apparatus of claim 7, wherein the operations performed by the processor further comprise: in response to receiving an electronic message comprising a product preference, configuring a shopper interest alert triggered as a function of the product preference and the shopper location.

9. The apparatus of claim 1, wherein the operations performed by the processor further comprise sending an electronic message comprising a product identification determined as a function of shopper location and product expiration time.

10. The apparatus of claim 1, wherein the operations performed by the processor further comprise receiving an electronic message comprising a fee amount to be added to the discounted price.

11. The apparatus of claim 10, wherein the operations performed by the processor further comprise sending an electronic message comprising the offer price determined as a function of the fee amount added to the discounted price.

12. An apparatus, comprising:
a perishable product inventory control system configured to reduce product inventory with a product discounting action executed in response to a perishable product surplus predicted by the system, comprising:
a processor; and,
a memory that is not a transitory propagating signal, the memory operably coupled with the processor and encoding computer readable instructions, including processor executable program instructions, the computer readable instructions accessible to the processor, wherein the processor executable program instructions, when executed by the processor, cause the processor to perform operations comprising:
receive an electronic message comprising a product inventory level, product location, and product consumption rate;
receive an electronic message comprising a shopper product preference, including the shopper preferred product location;
receive an electronic message comprising the shopper location;
predict a perishable product surplus quantity at a location and time determined as a function of the product expiration time and product consumption rate;
in response to receiving an electronic message comprising a price threshold, configure a discount price alert triggered as a function of comparing the discounted product surplus price to the price threshold;
determine a perishable product surplus price discounted as a function of the perishable product surplus expiration time;
associate the predicted product surplus location and time to the shopper having the product preference for the discounted price at the shopper location and time;
send an electronic message comprising the discount price alert; and,
automatically offer the shopper a portion of the product surplus at the discounted price.

13. The apparatus of claim 12, wherein the electronic message comprising a shopper product preference further comprises a product category the shopper is not interested in.

14. The apparatus of claim 12, wherein the operations performed by the processor further comprise: in response to receiving an electronic message comprising a radius from the shopper's preferred product location, configure a product location alert triggered as a function of the product location and the radius from the shopper's preferred product location.

15. The apparatus of claim 14, wherein the operations performed by the processor further comprise associating the product location to the shopper based on comparing the product location and the radius from the shopper's preferred product location.

16. The apparatus of claim 15, wherein the operations performed by the processor further comprise sending an electronic message comprising the product location alert.

17. The apparatus of claim 12, wherein automatically offer the shopper a portion of the product surplus at the discounted price further comprises sending an electronic message authenticated as a function of a cryptographically secure random number generator seeded based on data selected by the shopper.

18. An apparatus, comprising:
a perishable product inventory control system configured to reduce product inventory with a product discounting action executed in response to a perishable product surplus predicted by the system, comprising:
a processor; and,
a memory that is not a transitory propagating signal, the memory operably coupled with the processor and encoding computer readable instructions, including processor executable program instructions, the computer readable instructions accessible to the processor, wherein the processor executable program instructions, when executed by the processor, cause the processor to perform operations comprising:
receive an electronic message comprising a product inventory level, product location, and product consumption rate;
receive an electronic message comprising a shopper product preference, including the shopper preferred product location;
receive an electronic message comprising the shopper location;
predict a perishable product surplus quantity at a location and time determined as a function of the product expiration time and product consumption rate;
configure a product location alert triggered as a function of the product location and the radius from the shopper's preferred product location;
determine a perishable product surplus price discounted as a function of the perishable product surplus expiration time;
associate the predicted product surplus location and time to the shopper having the product preference for the discounted price at the shopper location and time;
send an electronic message comprising the product location alert; and,
automatically offer the shopper a portion of the product surplus at the discounted price.

19. The apparatus of claim 18, wherein the operations performed by the processor further comprise authenticating a seller to a buyer.

20. The apparatus of claim 18, wherein the operations performed by the processor further comprise sending to a seller a portion of a payment received from a buyer.
